(19) United States
(12) Patent Application Publication
(10) Pub. No.: US 2007/0141328 A1
(43) Pub. Date: Jun. 21, 2007

(54) Decorative protective film

(76) Inventor: Kehju Kamiyama, Yamagata (JP)

Correspondence Address: 3M INNOVATIVE PROPERTIES COMPANY, PO BOX 33427, ST. PAUL, MN, 55133-3427, US

(21) Appl. No.: 10/595,497

(22) PCT Filed: Sep. 27, 2004
(86) PCT No.: PCT/US04/31687

§ 371 Date: Apr. 24, 2006

Related U.S. Application Data
(60) Provisional application No. 60/514,987, filed on Oct. 28, 2003.

(51) Int. Cl. B05D 5/00; B05D 7/00

(52) U.S. Cl. 428/343; 428/354; 427/407.1; 427/261; 156/212

(57) ABSTRACT

The present invention provides a protective film which can be adhered to a substrate having a three-dimensional characteristic. This can be achieved even when the operation is conducted in-situ at temperatures of 40° C. to 60° C. The decorative protective film comprises a toughening layer, a protective (preferably embossable) layer, and an adhesive layer. The protective layer is on one side of the toughening layer. The adhesive layer is on the other side of the toughening layer. The protective layer comprises a thermoplastic amorphous polyester resin having a tensile modulus of 400 to 2100 MPa. The toughening layer comprises a polyurethane resin having a glass transition temperature of −50&deg;C. to 0&deg;C. The toughening layer may be colored.

### CROSS REFERENCE TO RELATED APPLICATION

This application claims the benefit under 35 USC §119(e) of U.S. Provisional Application No. 60/514,987 filed Oct. 28, 2003, the contents of which in its entirety is hereby incorporated by reference.

### FIELD

The present invention relates to a protective film, and particularly to a decorative protective film that is adhered to a substrate having a three-dimensional surface. Examples of such substrates include furniture, an exterior or interior surface of a building, a vending machine, or a sign. The film is intended to, among other things, protect and optionally also decorate the substrate.

### BACKGROUND

Protective films are known. Typically they are a thermoplastic sheet having a decorative image on one surface and an adhesive layer on the other surface. They are commonly used to provide decorative images on a substrate that has a two or three-dimensional surface. Such films are usually adhered to a substrate by one of the following two methods:

(1) The film is positioned on the substrate, heated in place to a given temperature, generally 40 to 60° C., and adhered to the article under heat and pressure.

(2) The film is adhered to the substrate by a molding method, such as vacuum molding under heating and the like.

Protective films generally contain poly(vinyl chloride). Although poly(vinyl chloride) has good heat moldability and good protective properties such as wear resistance, chemical resistance and the like, there are concerns over its disposal and recyclability.

Polyolefins or polyester sheets have been proposed as replacements for the poly(vinyl chloride) in protective sheets. See for example, Japanese Kokai Publication Nos. 48014/1996 and 2000-94596. Other decorative films are also disclosed in WO 02/081231.

One concern with the use of polyolefins is that they generally have softening temperatures that are too high—more than 100° C. Many polyesters have a glass transition temperature of 60 to 85° C. It can be difficult to apply sheets having softening temperatures above 60° C. using many hand-held hot air blowers (the first method of application described above) and the second method of application described above. Furthermore, such decorative sheets are exposed to continuous loads, scrapes, or abrasion, and decorative sheets of polyolefins can be torn if impacted by a sharp or heavy objects.

What is needed is a decorative film having low or no poly(vinyl chloride) content that can be easily conformed to a substrate, adhered to the substrate at 60 to 85° C. during in-situ application, and have impact, tear and abrasion resistance.

Surprisingly, it has been found that the present invention provides a protective film having very good impact and mar resistance over the long term without sacrificing conformability at mild application temperatures such as when a hot air blower is used, and without sacrificing appearance. Furthermore, this is achieved without including poly(vinyl chloride) as a resin into the decorative protective material of the invention.

### BRIEF DESCRIPTION

The presents invention comprises a decorative protective film which can be adhered and conformed onto a two or three-dimensional surface (sometimes also referred to herein as a substrate), even when such an application is conducted in situ at a temperature in the range of 40 to 60° C. Moreover, the protective film of the invention exhibits excellent conformability to the substrate to which it is applied even at such mild application temperatures. Advantageously, the decorative protective film of the present invention does not utilize poly(vinyl chloride), and further has a good impact resistance.

In one embodiment of the invention, the decorative protective film comprises a toughening layer having first and second major opposed surfaces; and a protective layer also having first and second major opposed surfaces, and an adhesive layer. The toughening layer is situated between the protective layer and the adhesive layer. In this configuration, the second surface of the protective layer is bonded to the first surface of the toughening layer and the first surface of the adhesive layer is bonded to the second surface of the toughening layer. The toughening layer comprises a thermoplastic polyurethane polymer having a glass transition temperature of from −50° C. to 0° C. The protective layer has a tensile modulus in the range of from 400 to 2100 (preferably in the range of from 400 to 1300 Mpa) as measured by ASTM D638 and comprises an amorphous thermoplastic polyester resin. The adhesive layer preferably comprises a pressure sensitive adhesive.

As used herein, the glass transition temperature means the peak temperature determined by dynamic mechanical analysis performed at a scan rate of 5° C./min. and a frequency of 62.8 rad/sec measured according to JIS K 7121.

In a further embodiment of the invention, the decorative protective film may be decorated. As used herein the term decorated means the presence of a modified surface finish, indicia such as letters, patterns, images and the like. The decoration may be present on an exposed surface of the film or present at an interface between one or more layers of the film. When the film comprises a decorated interface the interface is preferably between the protective layer and the toughening layer. The decorated interface can be produced by either decorating the second surface of the protective layer or by decorating the first surface of the toughening layer.

In a further embodiment of the invention, the protective film comprises an amorphous thermoplastic polyester resin having a glass transition temperature in the range of from 20° C. to 60° C., preferably from 30° C. to 60° C.

In yet another embodiment, the invention comprises a substrate to which the protective film is applied.

Other embodiments of the invention include methods of making and using the protective film.

### BRIEF DESCRIPTION OF THE DRAWINGS

FIG. 1 is a cross sectional view of one embodiment of the protective film of the present invention.

FIG. 2 is a cross-sectional view of a second embodiment of the protective film of the invention having an embossed surface pattern and printed indicia thereon.

### DETAILED DESCRIPTION

Decorative Protective Film

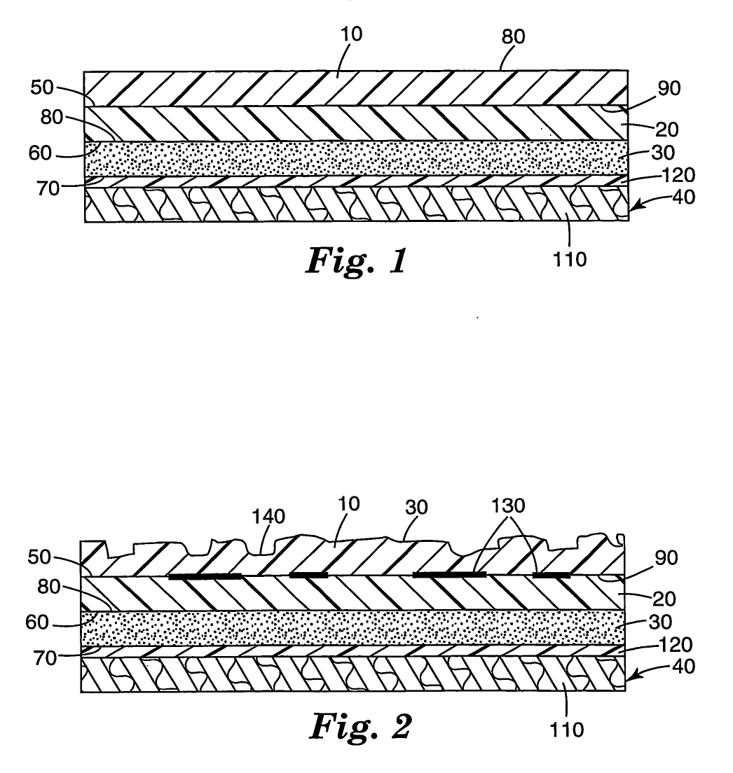

The protective film of FIG. 1 comprises a protective layer 10, a toughening layer 20, an adhesive layer 30 and an optional liner 40. Liner 40 comprises base layer 110 and release layer 120. Useful release layers include, for example, silicone based materials. Useful release liners are known and typically include, for example, paper. Protective layer 10 has free surface 80 and is in interfacial contact with first surface 50 of toughening layer 20. One surface of adhesive layer 30 is in interfacial contact with second surface 60 of toughening layer 20. The other surface of adhesive layer 30 is in interfacial contact with release layer 120 of liner 40. Adhesive layer 30 is preferably tacky at room temperature, i.e., it comprises a pressure sensitive adhesive. However, if the adhesive layer is not tacky at room temperature, for example when it is an activatable adhesive layer such as a hot-melt adhesive layer, then a release liner may not be necessary.

Materials useful as adhesive layer include (but are not limited to) pressure sensitive adhesives, solvent-activated adhesives such as organic solvent-activated or water-activated adhesive layers, heat-activated adhesive layers (wherein an adhesive layer is heated and changes irreversibly from a non-tacky adhesive layer to a tacky adhesive layer), a light activated adhesive layer (wherein the adhesive layer is irradiated and becomes tacky—either temporarily or permanently) or other type of adhesive layer.

Optionally, a primer layer (not shown) may be located between the protective layer 10 and the toughening layer 20. Additionally, an adhesive prime layer (not shown) may be located between the toughening layer 20 and the adhesive layer 30 to facilitate adhesion between the two. The primer layer may enhance interlayer adhesion, enhance printing ink adhesion to one or more layers, improve print quality or any combination of these. The primer layer may be decorated or otherwise printed.

The adhesive layer 30 is typically a layer of pressure-sensitive adhesive. The adhesive layer 30 can be applied to the toughening layer 20. When a prime layer is present between the protective layer and the toughening layer, the adhesive layer 30 may be applied to the free surface of the prime layer.

The first (or free) surface of the protective layer 10 may be embossed, pressed, cut, ablated, etched, printed, painted, calendered or otherwise decorated to give the adhesive sheet a decorated finish. One example of such decoration is shown in FIG. 2. In FIG. 2, the free surface comprises an embossed surface 140. The decorated finish can comprise finishes or indicia such as letters, patterns, or images. The images can be holograms, photographic color or monochrome images, silhouette images in color, black or white. The finish can be, for example, a wood grain appearance finish, a metallic appearance such as silver or gold. The patterns can be patterns of discreet images such as flowers, animal shapes, diamonds, squares, circles, dots, stripes, chevrons, pear shapes or teardrops, triangles, trapezia and the like.

The interfacial plane between the protective layer 10 and the toughening layer 20 may also be decorated. This may be accomplished by decorating second surface 90 of the protective layer or the first surface 50 of the toughening layer, or both. Decoration can be achieved by printing, etching, depositing, vapor coating, sputtering, adhering shaped foils, engraving, laser etching, coating and the like. Suitable printing techniques include gravure, inkjet printing (with solvent based inks by either continuous or drop-on-demand inkjet), and lithographic printing. In one embodiment of the invention, the decorated interface is made by, for example, printing a repeat pattern by gravure printing organic solvent based inks onto the first surface of the toughening layer. FIG. 2 also shows an embodiment having embossed surface 140 and indicia 130 at the interfacial plane. Indicia 130 can preferably be seen through protective layer 10.

The decorative protective film may also comprise a top layer (not shown) on the first surface 80 or 140 of the protective layer 10. The top layer can be a stain resistant or dirt resistant layer, a graffiti-resistant layer or other type of layer. Topy layer can be coated (for example by gravure printing, knife coating, meter or slot-die coating) or applied by lamination. Examples of materials useful as a top layer comprise one or more materials selected from the group consisting of high-surface energy polymers, ethylene-vinyl alcohol copolymers, ethylene vinyl alcohol acrylic terpolymers, acrylic polymers, fluoropolymers and copolymers of fluorine-containing monomers such as copolymers of polyvinylidene fluoride with acrylic monomers, silicone polymers, polyesters, polyurethanes and copolymers of urethanes, polymers of mixtures of the above monomer types, and polymer blends thereof. Poly(vinylidene) fluoride film is available from Denki Kagaku Kogyo of Tokyo, Japan. The top layer can either be a self-supporting polymer film (such as polyurethane) or an overlaminate that comprises a polymer film and an adhesive layer. In the former case, hot lamination is preferable to cold lamination. In the later case, the overlaminate preferably also comprises a release liner if the adhesive layer is a tacky pressure-sensitive or heat activatable layer at ambient temperatures.

Protective Layer

The protective layer useful in the invention may be formed from an amorphous polyester resin composition. Amorphous polyester resin is a soft resin and has good hand and conformability at application temperatures, e.g. at 40-60° C. Such temperatures can be obtained by heating with a hot air blower (such as a hair dryer) or the like. The amorphous polyester layer thus can be applied and conformed to curved and complex surface shapes and when softened under heat can be shaped around an article closely following the contours of the article. Preferably the amorphous polyester protective layer has a good heat extensibility. This is advantageous for enhancing shape compatibility to curved surfaces during hand application of the decorative protective film to an article. Because of the good extensibility, the protective film may be heated and the hot material stretched over the article, closely conforming the decorative protective film to the article. The amorphous polyester resin also preferably has high light transparency, and advantageously has a low tendency to whiten when stretched. The protective layer also preferably exhibits good solvent resistance.

Although it is preferred that the protective layer be substantially transparent and colorless, it may be translucent or colored or both for enhancing design properties of the decorative protective film. The protective layer generally has a light transmittance of not less than 65%, preferably not less than 70%. Light transmittance is measured according to JIS K 7105.

The protective layer typically has a thickness of from 30 to 300 microns. However, thinner or thicker films may also be used. Films having a thickness in the range of from 40 to 200 microns and preferably from 70 to 100 microns thick, are commonly used.

The ability of the protective layer to elongate (or stretch partially) governs the elongation of the protective film of the present invention. It is therefore preferred that the protective layer have an elongation of at least 30% at 40° C. and of less than 400% at 60° C. Elongation is determined after the protective film has been left for 10 minutes at a given temperature under a tension of 9.8 N/25 mm. Generally, the ability of the protective film to conform to a curved or complex-shaped surface is somewhat decreased when the elongation at 40° C. is less than 30%. If the elongation at 60° C. is more than 400% at 60° C., the protective film may deform or even break when it is shaped, stretched or conformed over a curved or complex-shaped surface at a relatively high temperature immediately after heating. Preferably the protective film has an elongation of at least 33% at 40° C. and an elongation of less than 350% at 60° C.

At 50° C., the protective film preferably has an elongation of 100 to 350%, and preferably an elongation of 150 to 300%.

The protective layer has a tensile modulus of at least 400, typically from 400 to 2100, preferably from 400 to 1300, MPa as measured by ASTM D638. More preferably, the tensile modulus of the protective layer is from 500 to 1100 MPa and most preferably from 600 to 1000 MPa. If the protective layer has a tensile modulus of less than 400 MPa, a continuous load can damage the protective layer when in combination with the toughening layers of the invention. If the tensile modulus of the protective layer is too high, then generally it will be very difficult to apply the decorative protective film or laminate film over a three dimensional complex surface or a three-dimensional curved surface using a hand-held hot air blower.

The protective layer may be subjected to techniques of embossing or calendaring to enhance design properties, as long such techniques do not adversely affect the performance of the protective film. Embossing can give protrusions on the surface and a combination of the protrusions and the portions around the protrusions can give a three-dimensional appearance to the decorative finish. Calendering makes the protective layer smooth and reduces surface roughness, and can impart a high specular gloss giving a very glossy appearance. Other finishes may be contemplated such as snakeskin, leather-appearance, patterns to reduce gloss etc.

The protective layer is formed from a resin composition that contains a thermoplastic amorphous polyester resin. The polyester resin composition preferably has a glass transition temperature of 20 to 60° C., a tensile modulus of 400 MPa and excellent transparency.

In a preferred embodiment of the invention, the amorphous polyester resin composition comprises (i) a phthalate type polyester resin, such as polyethylene terephthalate, polybutylene terephthalate, polyethylene naphthalate and the like; and (ii) a polyether compound that is at least partially compatible with the phthalate type polyester resin. In this combination, the phthalate type polyester resin behaves as a thermoplastic resin and the polyether compound behaves as a plasticizer or softening agent. The combination has a large elongation even at a relatively low temperature and exhibits good toughness even at relatively high temperature. The amorphous resin composition provides shape compatibility to a curved surface when the decorative protective film is adhered by hand at a temperature of 40 to 60° C.

A phthalate type polyester resin has, in one molecule, both (a) a repeat unit derived from phthalic acid or naphthalic acid, such as terephthalic acid, isophthalic acid or naphthalic acid, and (b) a repeat unit derived from a diol. The polyester can be prepared by reacting a dicarboxylic acid or acid anhydride (e.g. phthalic acid or phthalic anhydride) and a diol by condensation polymerization. The dicarboxylic acid or its derivative can be those other than phthalic acid or a phthalic derivative. The amorphous polyester resin preferably has a number average molecular weight of at least 10,000, more preferably of 15,000 to 1,000,000. The amorphous polyester sheets and webs are commercially available, for example, as Easter PETG polyester, available from Eastman Kodak Co.

The diols can be a mixture of a linear aliphatic diol (such as ethylene glycol, butan-1,4-diol, hexan-1,6-diol, caprolactone diol and the like); and an alicyclic diol (such as 1,4-cyclohexane methandiol, cyclohexane diol and the like). The amorphous polyester is preferably prepared from the diol mixture as mentioned above. The amorphous polyester resin can easily give shape compatibility to a curved surface when the decorative protective film is adhered by hand at a temperature of 40 to 60° C.

It is preferred that the amorphous polyester resin employ a weight ratio of the linear aliphatic diol to the alicyclic diol in the range of from 10:60 to 80:20.

The polyether compound useful in the invention can be an alkylene glycol type ether compound which contains a repeating unit of alkylene glycol having from 2 to 6 carbon atoms. The alkylene glycol type ether compound includes 1) a polyalkylene glycol diether obtained by alkyl-etherifying both ends of a polyalkylene glycol (e.g. polyethylene glycol or tetramethylene glycol), and 2) a polyester ether having both alkylene glycol units and a dicarboxylic acid unit. The alkyl group for etherifying preferably includes a lower alkyl group (having not more than 3 carbon atoms), such as methyl group, ethyl group or a propyl group. Examples of dicarboxylic acids for 2) include aromatic dicarboxylic acids, such as terephthalic acid, isophthalic acid, phthalic acid, 2,6-naphthalene dicarboxylic acid, 1,5-naphthalene dicarboxylic acid and the like.

The polyalkylene glycol unit of the polyether compound is preferably a polyethylene glycol unit, which can produce a polymer having a large elongation even at a relatively low temperature and having good toughness even at a relatively high temperature.

The polyether compound generally has a number average molecular weight of 400 to 6,000, preferably 450 to 3,000, more preferably 500 to 3,000. Molecular weights more than 6,000 can reduce the elongation of the resin composition at low temperatures and molecular weights of less than 400 can reduce the toughness of the resin composition at higher temperatures.

The polyether compound typically has a melting point of 150 to 250° C., a melt viscosity of 500 to 30,000 poise when determined at a shear rate of 100 sec⁻¹ and at a temperature of 250° C. The polyether compound preferably has a glass transition temperature Tg of −50 to 30° C., more preferably −40 to 25° C., most preferably −30 to 20° C.

Useful polyether compounds are commercially available. Such compounds include, for example, BUTYCEL, BUTYCENOL, KYOWANOL available from KYOWA HAKKO KOGYO Co., Ltd., and the like.

The polyester resin composition can be formed into a film by conventional film-forming methods, such as extruding or extrusion coating to easily obtain a polyester film for use as the protective layer.

The polyester resin composition may contain other additives, so long as the other additives do not excessively deteriorate the transparency or the heat extensibility of the protective sheet of the invention. Other additives that can be contained within the protective layer include, but are not limited to, colorants (such as dyes or pigments), plasticizers, softening agents, surfactants, fillers (including glass beads or ceramic beads and inorganic powders and minerals), crosslinking agents, flame retardants, ultraviolet absorbers, hindered amine light stabilizers, oxidation stabilizers, anti-fungal agents and the like. The protective layer preferably contains additives in an amount not exceeding 20 parts by weight of all additives per 100 parts by weight of the polyester.

Toughening Layer

The toughening layer used in the present invention comprises a thermoplastic polyurethane resin as discussed above. The layer may contain colorant if desired. Additionally, the toughening layer may have indicia thereon if desired.

The colorant may be incorporated into the toughening layer, or alternatively, it may be provided as a discrete layer on the toughening layer. Likewise, the indicia may be provided as discrete markings on the toughening layer. Alternatively, they may be provided as markings on a discrete layer which is in turn present on the toughening layer. The colorant and/or indicia may be present on either or both opposed surfaces of the toughening layer. Either the colorant or the indicia can provide a continuous color or provide opacity and hiding power or both opacity and color to the film of the invention. As used herein, indicia means alpha/numeric characters, symbols, designs, or other features that convey information or a decorative feature. The indicia can, but do not have to cover the whole of one of the surfaces of the toughening layer. Application of the indicia may be carried out by electrostatic printing, gravure printing, screen printing, inkjet printing and the like. Additionally, it can be carried out by etching, embossing, etc.

The toughening layer may be prepared by providing a composition containing the thermoplastic polyurethane resin, coating it onto a surface and hardening (drying or curing) it. The coating composition may be either melted to provide the coating liquid for the toughening layer, or mixed with a solvent to provide a liquid mixture which can then be coated. It is preferred that the toughening layer be colored. Coating can be accomplished by a notch bar (knife edge), wire-wrapped bar, a round bar, extrusion coating, meter roll coating, slot dye coating or the like as is well known in the coatings industry.

The toughening layer may also be formed by melt-extruding a material containing a film-forming polymer. The toughening layer may be applied to a temporary support sheet before final application to the film of the invention. Alternatively, it may be applied in a continuous manufacturing process.

The thermoplastic polyurethane resin useful in the invention has a glass transition from −50° C. to 0° C. Preferably, it has a light transmittance of not less than 60%, more preferably not less than 70%. The toughening layer in combination with the protective layer (herein referred to as the laminate film) has a high degree of flexibility. The toughening layer also imparts toughness to the protective layer, improving the impact resistance of the decorative film. It has been determined using Gardner impact tests (907 g load), that without the toughening layer, the protective layer formed from amorphous thermoplastic polyester is more easily torn in use by impact from objects. For example, without the toughening layer, a film used to protect a desk or cushion, tears when other objects slide across it.

Colorants useful in the invention include dyes and pigments. The colorants may be organic or inorganic materials. Pigments are preferred as colorants. Preferred pigments include quinacridone pigments, isoindolinone pigments, carbon black, titanium dioxide, silica, talc, calcium carbonate and copper phthalocyanin pigments.

The colorant imparts color to the decorative protective film and can provide hiding power. Hiding power is a measure of how well the protective film of the invention hides patterns on the surface of the substrate after application.

The toughening layer may also contain additional additives. Examples of such additives include metal gloss particles, plasticizers, softening agents, surfactants, fillers (including glass beads or ceramic beads and inorganic powders such as carbon black or silica), crosslinking agents, flame retardants, ultraviolet absorbers, hindered amine light stabilizers, oxidation stabilizers, antifungal agents and the like. Preferably the toughening layer contains a total amount of additives in an amount not exceeding 30 parts by weight per 100 parts by weight of the thermoplastic polyurethane resin.

The toughening layer preferably has good elongation for easy operation of adhering. The thickness of the toughening layer is from 10 μm to 400 μm and preferably from 15 to 200 μm.

Adhesive Layer

The adhesive layer generally comprises a polymeric material. Examples of useful polymers include acrylic polymers, silicone polymers, α-polyolefin polymers, rubber polymers (e.g. synthetic rubber, such as styrene-butadiene-styrene SBS etc. or natural-rubber based polymers), polyurethane polymers or the like. Acrylic polymers are defined herein include polymers and copolymers of acrylic acid, methacrylic acid and esters thereof. Acrylic copolymers also include copolymers of ionic monomers with acrylic acid, methacrylic acid, etc.

The adhesive layer may be pressure sensitive. An example of a useful pressure sensitive adhesive layer is an acrylic polymer based adhesive. Such polymers may be used alone or in combination with one another. They may be prepared by polymerizing a monomer mixture containing suitable monomers. Polymerization can be conducted by conventional methods, such as solution polymerization, bulk polymerization, emulsion polymerization or the like.

Acrylic adhesive polymers may generally be prepared by polymerizing a monomer mixture of (A) an alkyl acrylate having 4 to 8 carbon atoms and (B) an (meth)acrylic acid monomer having a carboxylic group in a molecule. Another monomer to be copolymerized with the above two monomers, such as (meth)acrylic monomer and a vinyl-group containing monomer can also be used.

Examples of monomer (A) that may be used include n-butyl acrylate, isobutyl acrylate, isooctyl acrylate, 2-ethylhexyl acrylate, N,N-dimethyl acrylamide, and the like. Examples of monomer (B) that may be used include (meth)acrylic acid. Examples of other monomers that may be used include phenoxyethyl acrylate, phenoxypropyl acrylate, 2-hydroxyethyl(meth)acrylate, 2-hydroxypropyl(meth)acrylate, 2-hydroxymethyl (meth)acrylate, hydroxy-3-phenoxypropyl acrylate, glycidyl(meth)acrylate, acryloyl benzophenone and the like.

The adhesive polymer is typically crosslinked. Crosslinking may be achieved by reacting a crosslinking agent with the polymer. Suitable crosslinking agents include, but are not limited to, isocyanate compounds, epoxy compounds, bis-amide compounds, aziridines and the like. The amount of crosslinking agent in the adhesive layer is usually 0.1 to 5 parts by weight per 100 parts by weight of the adhesive polymer. Other useful crosslinking methods include free-radical crosslinking which may be initiated photochemically, thermally with or without the aid of photoinitiators.

The adhesive layer may also contain elastic microspheres or crystalline polymers, so long as they do not adversely affect the performance of the present invention. The adhesive layer may be a repositionable, removable, positionable adhesives, or permanent. The adhesive layer typically has a thickness of 5 to 200 μm, preferably 10 to 100 μm, as long as the purpose of the present invention can be attained.

Adhesives can also be selected from a variety of conventional adhesive formulations. Non-limiting examples of adhesives include pressure sensitive adhesives, hot melt adhesives, heat activated adhesives that are pressure sensitive adhesives at the time of application. Some suitable adhesives are disclosed in U.S. Pat. Nos. 4,994,322; 4,968,562; 5,296,277; 5,362,516 and 5,141,790. These references disclose both adhesive compositions and adhesive structures and associated release liners useful in the invention. Other types of adhesive include pressure sensitive adhesives disclosed in Satas et al. Handbook of Pressure Sensitive Adhesives, 2^{nd} Edition (Von Nostrand Reinhold, N.Y., 1989). The layer of adhesive can cover all or part of the second surface of the toughening layer.

Primer Layer

An optional primer layer may be employed to enhance the adhesion between the amorphous polyester protective layer and a polyurethane layer. The choice of material used in the primer layer is dependent upon the nature of the protection layer and the toughening layer. The primer layer may be applied to either on the first surface of the toughening layer, to the second surface of the protective layer or to both. The primer layer may comprise a polymer having affinity with both the toughening layer and the protective layer. Examples of polymers useful in the primer layer include a vinyl acetate copolymer, a urethane elastomer and an (meth)acrylic polymer.

A specific example of a urethane elastomer useful in the primer layer is a polyurethane elastomer obtained by polymerizing a polyol and a diisocyanate.

The primer layer typically has a thickness of 0.1 to 30 μm, preferably 0.5 to 10 μm. Also, the primer layer preferably has a light transmittance of at least 80%, preferably at least 85%.

The primer layer may be applied by coating a solution containing the primer polymer on either or both of the toughening layer and the protective layer, and hardening the primer by curing or drying. Coating methods known in the art such as a gravure coating, a bar coating (such as notch bar or knife edge, wire-wrapped bar and other similar metering methods), a roll coater such as meter roll coating, a die coater or the like, may be used to apply the primer layer.

Release Liner

The optional release liner comprises a base and a release layer. Typically the release layer will be a silicone base release layer. The base can comprise paper, plastic, plastic-coated paper, or a film-forming layer.

The free surface of the base defines the second surface of the release liner, and the free surface of the release layer defines the first surface of the release liner (also called the release surface of the release liner).

The release surface of the liner may be substantially flat or have an embossed or otherwise structured surface. The structured surface may be formed by embossing, hardening the release layer in contact with a structured surface, heat and pressure or other methods. Structured release liners, structured adhesive layers and methods for making and using them are known in the art. References that disclose release liners or adhesive layers or both include US Patent Application Publication Numbers 03-0017291-A1, 03-0178124-A1, 03-0152695-A1 03-0082371-A1; and U.S. Pat. Nos. 6,524,649, 6,524,675, 6,197,397, 5,650,215, 6,440,880, 6,123,890, 5,449,540 and 5,449,540. Other references that disclose release liners include copending application Ser. Nos. 10/610,005, (Filed Jun. 30, 2003) and 10/621,658 (Filed Jul. 17, 2003).

Method of Forming the Protective Film

The following discussion sets forth various steps used in the manufacture of the present invention. This disclosure represents non-limiting discussion of how the film may be made. As used herein, extrusion generally refers to forcing a molten liquid at elevated temperatures through a die or dies into a nip and cooling the molten liquid (melt) to form a self-supporting sheet. Extrusion coating is refers to coating a molten liquid onto a support and allowing the liquid to cool and thereby harden.

Coating refers to forming a layer of a coating liquid on a web or sheet of base material. When the coating liquid is a molten liquid (a melt), then hardening comprises cooling the layer of the coating liquid so that the layer either hardens to a solid or increases greatly in viscosity. When the coating liquid is a solution, emulsion or dispersion, then hardening the coating liquid includes the step of drying the coating, i.e. heating the layer of coating liquid to drive off the solvent (e.g. an organic solvent or water) thus producing a dried coating. When the coating liquid is a liquid mixture at ambient temperature containing reactive diluents, then the step of hardening the liquid coating layer comprises the step of causing the reactive diluent to react with other components in the mixture to harden the coating layer. This can for example be accomplished by heating the coating, irradiating the coating with actinic radiation, or simply waiting (if for example the reactive diluent is introduced into the coating liquid at the coating head). Therefore depending on the nature of the coating liquid, hardening can be drying, solidifying, crosslinking or curing or any combination of one or more of these processes.

The polyester resin composition for the protective layer can be formed into a polyester film by any conventional film-forming method. The film-forming method may include extrusion, extrusion coating onto a temporary support, extrusion by the T-die method, extrusion by the blown film method, calendering, casting, coating onto a support or the like.

The polyester film used for the protective layer may be prepared as follows. An amorphous copolyester resin, optionally mixed with a polyether compound in a particular weight-ratio, is prepared and, if necessary, dried at 100° C. to 150° C. for several hours (e.g., up to 10 hours) to obtain a starting resin. The starting resin is then extruded at a desired temperature, generally 180° C. to 280° C. and at a desired extrusion-die temperature, generally 180° C. to 260° C. The extruded film is then quenched by a casting roller to form a polyester film. The polyester film is a non-extended film, but if necessary, it may be monoaxially or biaxially oriented.

If the polyester includes a polyether compound, the weight ratio of the amorphous copolyester resin to the polyether compound is preferably within the range of from 70:30 to 99:1, more preferably in the range of from 80:20 to 97:3, and most preferably in the range of from 85:15 to 95:5. As the level of the amorphous copolyester resin increases, the elongation of the protective layer at a lower temperature is reduced. As the polyether content of the protective layer is increased, the toughness of the protective layer at higher temperatures is reduced.

The toughening layer to a major surface of the protective layer may be accomplished as follows. The second surface of the polyester film may be heat laminated with pressure to the first surface of the toughening layer. Any temporary support for the toughening layer may then be stripped off the second surface of the toughening layer to yield a laminate film of the protective layer and the toughening layer.

In another method, the toughening layer may be applied to the protective layer by coating a liquid composition of the polyurethane onto the second surface of the protective layer, and hardening the toughening layer to produce the laminate film. The toughening layer coating composition may be an emulsion, dispersion, solution, suspension or other type of coating liquid containing the components of the toughening layer. For example, the toughening layer coating liquid could contain an aqueous dispersion of the polyurethane resin component of the toughening layer with a dispersion of colorants and other additives. It is important that the toughening layer coating liquid does not dissolve or otherwise damage the protective layer onto which it is coated.

An adhesive layer may then be applied to the second surface of the toughening layer to form the protective film of the present invention. The adhesive layer may be applied by coating an adhesive coating liquid directly onto the second surface of the toughening layer. The liquid adhesive layer may then harden, and a release liner may optionally be laminated to the second surface of the adhesive layer (the free surface of the adhesive layer). Alternatively, a commercially available adhesive layer may be directly laminated to the toughening layer.

The adhesive layer may also be applied by coating a liquid adhesive composition onto a temporary support such as a release liner, then hardening the liquid adhesive and laminating the adhesive to the second surface of the toughening layer. When the adhesive layer is a pressure sensitive adhesive layer, the lamination step is carried out under pressure and can be carried out at ambient temperatures without extra heating. When the adhesive layer is a hot-melt adhesive layer, then the lamination step is usually carried out with heat and pressure at elevated temperatures. Lamination typically involves pressing two (or more) layers together in pair of rollers in contact with each other where the point of contact of the rollers defines a nip as is known in the art. Other methods are possible.

Coating the adhesive layer may be accomplished by, for example, coating from a liquid such as water or an organic solvent. When the adhesive layer is coated out of a liquid, an adhesive polymer is mixed with the liquid and any other ingredients such as tackifiers, crosslinking agents etc. to form a coating liquid. The coating liquid then comprises a solution of the adhesive polymer in the solvent, a dispersion of the adhesive polymer in the solvent, an emulsion of the polymer in the solvent, a suspension of the polymer in the solvent, or other type of mixture of the adhesive polymer with the solvent. Organic solvents can include but are not limited to methyl ethyl ketone, methyl isobutyl ketone, ethanol, isopropanol, toluene or a mixture of two or more thereof. The adhesive layer is then hardened by the drying adhesive layer by evaporating the solvent.

Some pressure sensitive adhesives and most heat activated adhesive layers may be hot-melt coated. In this case, one or more adhesive polymers is/are melted, mixed with other ingredients and extrusion coated (or alternatively extruded). Hardening comprises the step of cooling the molten adhesive layer to ambient temperature. There may be other steps in the coating of the adhesive layer such as irradiating the adhesive layer.

The protective film of the invention may have a decorated finish. The decorated finish may be made by decorating the first surface of the protective layer, by decorating both the first and second surfaces of the protective layer or by decorating either or both surfaces of the toughening layer. Decorating a design or pattern can comprise printing, embossing, etching, engraving or otherwise forming a design or pattern.

Decorating the film may be accomplished in several ways. If the layer to be decorated is a self-supporting film, the first (or first and second) surface(s) may be decorated before the protective layer and the toughening layer are joined together. Optionally, the first surface of the protective layer also be decorated after the protective layer and the toughening layer are joined together. The first surface of the protective layer may also be decorated after all layers of the decorative protective film have been joined together.

An embossed design or pattern may be provided in several ways. For example, if the protective layer is a self-supporting film, it can be decorated by embossing its first surface (or both of its major surfaces). This can be accomplished by feeding the protective layer through a heated nip, where the nip comprises a roller having an embossed or engraved or etched surface, and a second roller (normally made of an elastic material such as rubber). Other methods are possible such as flat bed pressure. One or more of the rollers in this process are heated to help soften the protective layer and facilitate the embossing process. In order to prevent sticking of the protective layer onto a heated embossing roll, preferred roll temperatures are 60-70° C.

Other methods of decorating the first surface of the protective layer or the toughening layer include gravure printing, inkjet printing, engraving, etching (dissolving portions of the surface), scratching, abrading screen printing, electrostatic printing, transferring pigment layers or layers comprising pigments etc.

Preferably the protective film of the invention (without a release liner) has a thickness of less than 200 microns, more preferably less than 170 microns.

Methods of Protecting a Substrate

The protective film of the invention may be applied to an article by removing the release liner (when present), applying the adhesive surface of the film to a substrate, heating the film (for example with a hand-held hot air blower), and smoothing the film down to remove trapped air bubbles. During this process the film may be stretched over protrusions, wrapped around edges, butted up against edges and otherwise molded to the surface to be protected. This process where air bubbles are removed and the film is molded to the shape of the surface which it is to protect is referred to as conforming the film to the substrate. The film may be smoothed by the hand or a squeegee or flat edge, a sponge or other known method. Preferably, sharp protrusions are avoided in this process. However, when present, care must be taken during the conforming step so as not to tear or puncture the film.

Another method of protecting a substrate comprises the steps of providing a laminate that comprises a protective layer and a toughening layer, applying an adhesive layer to the substrate to form an adhesive coated substrate, applying the second surface of the toughening layer of the laminate film to the adhesive layer, heating the laminate and conforming the laminate film to the adhesive-coated article. In this case, the adhesive layer does not need to be a continuous adhesive layer. For example, the adhesive layer could be discontinuous or patchy or applied in stripes, dots, or other discontinuous patterns. Preferably, the discontinuous adhesive layer is sufficient to bond the laminate film (the toughening layer of the laminate film) to the article. For example, the adhesive layer could be applied to an article by spraying the adhesive onto one or more surfaces of an article. Alternatively, a double sided adhesive (a sheet both major surfaces of which are adhesive surfaces) could be applied to an article.

Substrates to which the film of the invention can be applied include graphics, furniture such as desks, filing cabinets, desk sides and work surface tops, cushions, arms of chairs; building surfaces such as handrails for stairwells, doors, windows, escalator handrails, walls, drywall, concrete blocks, ceilings and ceiling tiles; posters and poster board surfaces, foam core posters, Sintra board and other plastic display boards; boxes, cartons, chests and trunks.

### EXAMPLES

A film of the present invention was prepared as follows. A present invention will be explained with reference to the following Examples. Unless otherwise stated, all percentages and ratios are by weight.

### Example 1

The protective layer was provided by using a 100 μm thick amorphous thermoplastic polyester film available from Tatsuta Chemical (of Yanagibashi, Taito-ku, Tokyo, Japan) under the trade name of SCAT SP-044. The polyester film had a tensile modulus of approximately 1100 MPa.

A 30% solution of polyurethane resin in a mixture of 5:2 methyl ethyl ketone (MEK) to methyl isobutyl ketone (MIBK) available as NIPPORAN YN-191 from Nippon Polyurethane Industry Co., Ltd. of Tokyo, Japan) was taken. The polyurethane solution (100 grams) was mixed with a pigment dispersion (ten grams) available as UTCO Series pigment dispersion (available from Dainichiseika Color & Chemicals Manufacturing Co., Ltd., of Tokyo, Japan). The UTCO Series dispersion contained black, blue, and silver-colored pigments. The concentration of the UTCO was less than 50% solids (weight per weight of dispersion). The mixture of the UTCO pigment dispersion and the NIPPORAN YN-191 formed a toughening layer coating liquid.

The toughening layer coating liquid was coated onto a temporary presized polyester at a wet thickness of 100 microns by knife coating. The liquid toughening layer was hardened by drying for two minutes at 150° C. The polyurethane of the toughening layer had a glass transition temperature of −2° C.

The free surface of the toughening layer was laminated to a major surface of the protective layer by passing the two through a heated nip (roll temperature was 200° C.) which pressed the protective layer and the polyurethane layer together bonding the two together. The temporary support was stripped off during this process giving a laminate film of the protective layer and a colored polyurethane layer.

An acrylic adhesive layer was laminated to the free surface of the polyurethane layer laminating by nip. The adhesive was an acrylic pressure sensitive adhesive on a liner. The dry thickness of the adhesive layer was approximately 43 microns thick. This gave a decorative protective film comprising a polyester protective layer, a polyurethane toughening layer, an adhesive layer and a release liner.

### Comparative Example 1

A film was prepared as described in Example 1, except that a different amorphous thermoplastic polyester was used. This polyester was SCAT SP-012 available from Tatsuta Chemical (of Yanagibashi, Taito-ku, Tokyo, Japan). The thickness of the polyester film was 100 μm (as in Example 1) but the tensile modulus was lower at approximately 400 MPa.

### Comparative Example 2

A film was prepared as described in Example 1 except that the polyurethane resin layer was replaced by an acrylic resin layer. The acrylic resin layer had a glass transition temperature of above 0° C. The acrylic coating liquid comprised a 30% solids solution of Paraloid B-48N (available from Rohm and Haas of Philadelphia, U.S.A.) in a solvent mixture of one part MEK, one part toluene and one part MIBK. The acrylic layer was dried at 150° C. for two minutes. The acrylic layer was laminated to the same polyester film as described in Example 1 in the same manner, and the temporary support removed to give a laminate film comprising a polyester layer and an acrylic layer. The same adhesive used in Example 1 was then laminated to the free surface of the acrylic layer.

### Comparative Example 3

A film was prepared as described in Example 1 except that the amorphous polyester film used had a thickness of 200 microns. The polyester used was SCAT SP-044 from Tatsuda Chemical.

Testing

Test Method 1

Two samples of each film of Example 1 and the film from Comparative Example 1 were tested. The release liner was removed from the adhesive layer of each sample, and the decorative protective film samples applied to a 1 mm thick aluminum plate (the free adhesive surface was laminated onto the aluminum plate). A 3 mm thick shock-absorbing material was placed over the film samples on the plate and a weight placed on top of each sample (on top of the shock absorbing material). Two different weights were used such that a pressure was applied to the film of 50 g/cm² for one sample and 100 g/cm² with the other sample. The samples were left under load in an oven at 40° C. for one week.

The damage to the polyester layer is recorded in TABLE 1.

TABLE 1

Example

| Load | 1 | C1 |
|---|---|---|
| 50 g/cm² | No damage observed | Surface damaged |
| 100 g/cm² | No damage observed | Surface damaged |

Test Method 2

Samples of the film from Example 1 and of Comparative Example 2 were adhered to a 1 mm thick aluminum plate, and impact resistance was measured according to JIS K5400 using a DuPont-type impact tester. Results are shown in TABLE 2.

TABLE 2

| | Energy/J | | | | | | | |
|---|---|---|---|---|---|---|---|---|
| Example | 1.13 | 2.26 | 3.39 | 4.52 | 5.65 | 6.78 | 7.91 | 9.04 |
| Example 1 | ◯ | ◯ | ◯ | ◯ | ◯ | ◯ | ◯ | ◯ |
| Comparative | ◯ | ◯ | ◯ | ◯ | ◯ | ◯ | X | X |
| Example 2 | | | | | | | | |

◯ = film not broken by impact
X = film was broken by impact

Test Method 3

The heat release rate and total heat release of three film samples from Example 1 and three film samples from Comparative Example 3 were measured using a cone calorimeter (available from Fire Testing Technology of East Grinstead, West Sussex, U.K.). The specimen surface area was 88.4 cm², heat flux 50 kW/m² and an exhaust duct flow rate of 24 liters/sec. The test results are shown in TABLE 3.

TABLE 3

| | | Maximum Heat | Time | Total Heat |
|---|---|---|---|---|
| | Polyester | Release | exceeding | Released (THR) |
| | layer | Rate (HRR)/ | 200 kW- | until Flameout/ |
| Example | thickness | kW-m⁻² | m⁻²/sec | MJ-m⁻² |
| Example 1 | 100 μm | 265 | 10 | 3.90 |
| | | 267 | 10 | 4.09 |
| | | 278 | 10 | 3.98 |
| Comparative | 200 μm | 336 | 14 | 6.08 |
| Example 3 | | 321 | 14 | 5.89 |
| | | 332 | 14 | 6.29 |

We claim:

1. A protective film, comprising:
a protective layer having a first surface and a second surface and a tensile modulus of from 400 to 2100 MPa, wherein the protective layer comprises an amorphous thermoplastic polyester resin;
a toughening layer having a first surface and a second surface, wherein the toughening layer comprises a polyurethane resin having a glass transition temperature in the range of from −50° C. to 0° C., and wherein the second surface of the protective layer is attached to the first surface of the toughening layer; and
an adhesive layer having a first surface and a second surface, wherein the first surface of the adhesive layer is bonded to the second surface of the toughening layer.

2. The protective film of claim 1, wherein the adhesive layer comprises an acrylic pressure sensitive adhesive.

3. The protective film of claim 1, further comprising a decorated interface between the protective layer and the toughening layer.

4. The protective film of claim 1, wherein the first surface of the protective layer comprises indicia thereon.

5. The protective film of claim 1, wherein the toughening layer contains a pigment.

6. The protective film of claim 1 wherein the amorphous thermoplastic polyester has a glass transition temperature in the range of from 20° C. to 60° C.

7. A decorated article, comprising:
a) a protective film comprising:
(i) a protective layer having a first surface and a second surface and has a tensile modulus of 400-2100 MPa; wherein the protective layer comprises an amorphous thermoplastic polyester resin;
(ii) a toughening layer having a first surface and a second surface, wherein the toughening layer comprises a polyurethane resin having a glass transition from −50° C. to 0° C., and wherein the second surface of the protective layer is attached to the first surface of the toughening layer, and
(iii) an adhesive layer having a first surface and a second surface, and wherein the first surface of the adhesive layer is bonded to the second surface of the toughening layer; and
b) an substrate having at least one major surface, wherein the second surface of the adhesive is adhered to and conformed to the major surface of the substrate,

8. The article of claim 7, wherein the amorphous polyester resin has a glass transition temperature in the range of from 20° C. to 60° C.

9. The article of claim 7, wherein the toughening layer is pigmented.

10. A method of preparing a protective film, comprising the steps of:
providing a layer of a thermoplastic amorphous polyester resin having a tensile modulus of 400-2100 MPa, the layer having first and second opposed surfaces;
applying a layer of a polyurethane resin having a glass transition temperature of −50° C. to 0° C. to the second surface of the polyester resin layer; and
applying an adhesive layer to the polyurethane resin layer.

11. The method of claim 10, further comprising the step of applying indicia to the first surface of the polyester resin layer.

12. The method of claim 11, wherein the step of applying indicia to comprises embossing the first surface of the polyester resin layer.

13. The method of claim 10 further comprising the step of printing the layer of polyurethane resin layer.

14. The method of claim 10 further comprising the step of applying indicia to the second surface of the polyester resin layer.

15. The method of claim 10 further comprising the step of providing indicia between the polyester resin layer and the polyurethane resin layer.

16. A method of preparing a protected article, comprising the steps of:
providing the protective film of claim 1;
applying the second surface of the adhesive layer to a substrate;
heating the protective film; and
conforming the protective film to the article.

17. The method of claim 16, wherein the amorphous thermoplastic polyester resin has a glass transition temperature of from 20° C. to 60° C.
